(19) United States
(12) Patent Application Publication
(10) Pub. No.: US 2026/0075317 A1
(43) Pub. Date: Mar. 12, 2026

(54) CONTROL APPARATUS, IMAGE PICKUP APPARATUS, CONTROL METHOD, AND STORAGE MEDIUM

(71) Applicant: CANON KABUSHIKI KAISHA, Tokyo (JP)

(72) Inventors: TAMAKI NEGISHI, Tokyo (JP); MAI NAKABAYASHI, Kanagawa (JP)

(21) Appl. No.: 19/298,387

(22) Filed: Aug. 13, 2025

(30) Foreign Application Priority Data
Sep. 9, 2024 (JP) 2024-154431

(51) Int. Cl. H04N 23/68; H04N 23/73

(52) U.S. Cl. CPC H04N 23/6812; H04N 23/683; H04N 23/6845; H04N 23/73

(57) ABSTRACT

Control apparatuses, image pickup apparatuses, control methods, and storage media are provided herein. One or more control apparatuses for use with an image pickup apparatus that includes an imaging unit configured to consecutively acquire a plurality of images, and a combining unit configured to combine the plurality of images based on a motion vector between the plurality of images may include one or more memories storing instructions, and one or more processors that, upon execution of the instructions, operate to estimate an offset component of an output of a detector configured to detect a shake of the image pickup apparatus, and change a setting for estimating the offset component between pre-imaging for consecutively acquiring a plurality of images that are used for live-view imaging, and normal imaging for consecutively acquiring the plurality of images that are used for the combining unit.

### BACKGROUND

### Field of the Technology

The aspect of the disclosure relates to one or more embodiments of a control apparatus, an image pickup apparatus, a control method, and a storage medium.

### Description of the Related Art

Image stabilization for suppressing the influence of camera shake etc. on an image uses an output signal from a detector configured to detect a shake of an image pickup apparatus, but the output signal includes DC components such as variations in reference voltage due to individual differences and drift due to temperature changes (collectively referred to as offset components hereinafter). Accordingly, a configuration has been proposed for estimating an offset component included in an output signal using a motion vector obtained from differences between a plurality of images acquired by an image sensor, and for removing an estimated offset component from the output signal. Japanese Patent Application Laid-Open No. 2019-124871 discloses a configuration that changes an update speed of an offset estimation value (or offset estimate) using the reliability of a motion vector.

The configuration disclosed in Japanese Patent Application Laid-Open No. 2019-124871 is effective in a case where continuous images are continuously acquired in a short cycle, such as during live-view imaging, but in still image capturing, a next image cannot be obtained until the end of exposure, and a motion vector cannot be obtained, so it is difficult to obtain the effect, especially in the long exposure. In addition, a motion vector cannot be acquired during exposure, and thus offset components contained in the output signal cannot be estimated or removed. The longer the exposure time is, the more significant the influence of the offset components becomes, and accurate image stabilization cannot be performed. Therefore, even if offset components are removed until the moment before the exposure start, the image stabilizing accuracy may decrease as the exposure time increases.

### SUMMARY

One or more embodiments of a control apparatus for use with an image pickup apparatus that includes an imaging unit configured to consecutively acquire a plurality of images, and a combining unit configured to combine the plurality of images based on a motion vector between the plurality of images may include one or more memories storing instructions, and one or more processors that, upon execution of the instructions, operate to estimate an offset component of an output of a detector configured to detect a shake of the image pickup apparatus, and change a setting for estimating the offset component between pre-imaging for consecutively acquiring a plurality of images that are used for live-view imaging, and normal imaging for consecutively acquiring the plurality of images that are used for the combining unit. One or more image pickup apparatuses may include one or more control apparatuses in accordance with one or more other aspects of the disclosure. One or more control methods corresponding to the above one or more control apparatuses also constitute another aspect of the disclosure. A storage medium storing a program that causes a computer to execute the above one or more control methods also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B explain a camera system according to this embodiment of the disclosure.

FIG. 2 explains offset component estimation.

FIGS. 3A and 3B illustrate a relationship between the exposure period and an image blur amount in image stabilization with image combination.

FIG. 4 is a block diagram of an image combining unit.

FIG. 5 is a flowchart illustrating processing of image stabilization with image combination.

FIG. 6 is a flowchart illustrating a still image capturing operation in performing image stabilization with image combination.

FIG. 7 is a flowchart illustrating processing during normal imaging.

FIG. 8 is a simplified diagram illustrating a change in an offset component removing amount due to a difference in an image acquiring interval.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

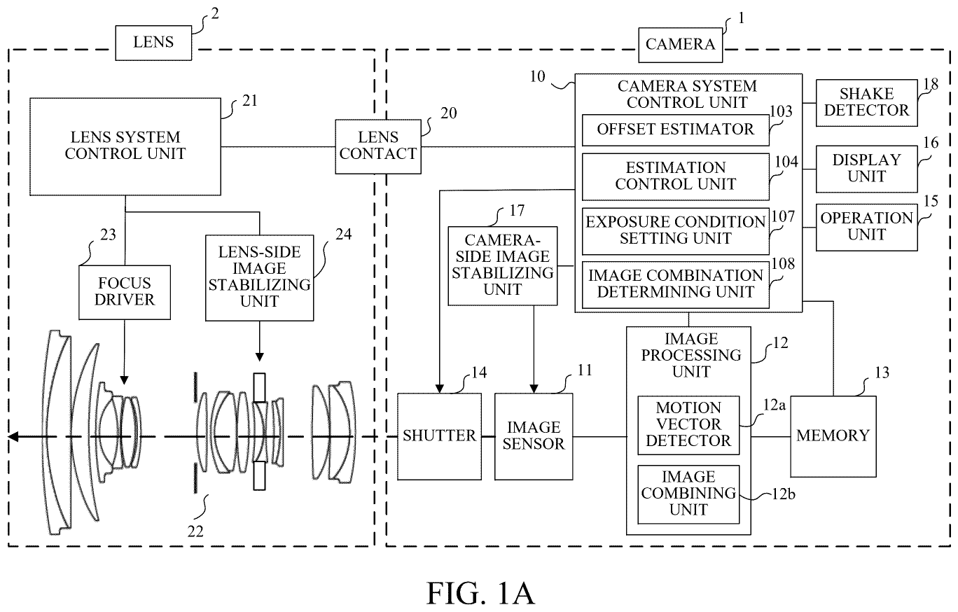

FIGS. 1A and 1B explain a camera system according to one embodiment of the disclosure. FIG. 1A is a block diagram of the camera system. FIG. 1B is a central sectional view of the camera system. This embodiment will discuss an interchangeable lens camera as an example, but the disclosure is also applicable to video cameras, digital still cameras, and electronic apparatuses having an imaging unit.

The camera system includes a camera (body) (image pickup apparatus) 1 and a lens (apparatus) 2. The camera 1 and the lens 2 can communicate electrical signals via a lens contact 20 that is electrically connected.

The camera 1 includes an image sensor (imaging unit) 11, an image processing unit 12, a memory (unit) 13, a focal plane shutter 14 (shutter hereinafter), an operation unit 15, a display unit 16, and a finder optical system 19. The image sensor 11 receives light that has passed through the lens 2. The image processing unit 12 generates an image from information photoelectrically converted by the image sensor 11. The image processing unit 12 includes a motion vector detector 12a and an image combining unit 12b. The memory 13 stores information such as image information. The shutter 14 controls the light shielding and passing toward the image sensor 11. The operation unit 15 recognizes a user operation. The display unit 16 displays images and the like. As illustrated in FIG. 1B, the display unit 16 has a rear LCD unit 16a disposed on the rear surface of the camera 1 and a finder display unit 16b disposed in the finder optical system 19 and viewable through an eyepiece lens 19a. The display unit 16 is controlled by a display control unit (not illustrated) configured to control a displayed image, and the user can arbitrarily switch between the rear LCD unit 16a and the finder display unit 16b. The display unit 16 can also display a live-view image before imaging via the camera system control unit 10 described later.

The camera 1 includes a camera system control unit (control apparatus) 10, a camera-side image stabilizing unit 17, and a shake detector (detector) 18. The camera-side image stabilizing unit 17 shifts the image sensor 11 in a direction approximately orthogonal to the optical axis. The shake detector 18 detects the shake of the camera 1 (movement occurring in the camera 1) and outputs a detection signal of the shake information (shake amount) of the camera 1 to the camera system control unit 10. The camera system control unit 10 includes an offset estimator (estimator) 103, an estimation control unit (change unit) 104, an exposure condition setting unit (setting unit) 107, and an image combination determining unit (determining unit) 108. The exposure condition setting unit 107 can automatically or manually set the total exposure time and the image acquiring interval described later. In the case of manual setting, the setting is performed via the operation unit 15. The exposure condition setting unit 107 can also determine whether the total exposure time and the image acquiring interval have been changed since the last imaging. The image combination determining unit 108 determines whether or not to perform the normal imaging described later from the total exposure time and the image acquiring interval set by the exposure condition setting unit 107.

The lens 2 includes a lens system control unit 21, an imaging optical system 22, a focus driver 23, and a lens-side image stabilizing unit 24. The lens system control unit 21 controls the lens 2. The imaging optical system 22 allows light to pass through it. The focus driver 23 moves a focus lens included in the imaging optical system 22. The lens-side image stabilizing unit 24 shifts a correction lens (image stabilizing lens) such as a shift lens included in the imaging optical system 22 in a direction substantially orthogonal to the optical axis.

The shutter 14 has a front curtain and a rear curtain, and controls the shielding and passing of light from the imaging optical system 22 toward the image sensor 11 by moving each shutter curtain within an opening. The driving of the shutter 14 is controlled by the camera system control unit 10.

The light that passes through the imaging optical system 22 and the opening in the shutter 14 and is received by the image sensor 11 is photoelectrically converted, and the photoelectric conversion output is quantized by an A/D converter (not illustrated). The image processing unit 12 includes a white balance circuit, a gamma correction circuit, an interpolation calculation circuit, etc., and generates image data from a signal acquired from the image sensor 11 upon receiving a command from the camera system control unit 10. The motion vector detector 12a detects a motion vector based on a comparison between a plurality of images obtained from the image sensor 11. The image combining unit 12b outputs image data obtained by aligning a plurality of images obtained continuously by the image sensor 11 and performing image combinations. The data output from the image combining unit 12b is stored in the memory 13.

The camera system control unit 10 includes a CPU and the like, and controls the camera 1, including communication with the lens 2. The camera system control unit 10 generates a timing signal and outputs it to each unit in imaging. In a case where the release button included in the operation unit 15 is pressed and an operation instruction is received, the camera system control unit 10 controls the image sensor 11 and transmits a command signal to the lens system control unit 21 according to the instruction. The release button can detect a so-called half-pressing operation (S1 operation hereinafter) in which the release button is pressed to the first stage, and a so-called full pressing operation (S2 operation hereinafter) in which the release button is pressed further to the second stage. In a case where the S1 operation is detected, a command is issued for an imaging preparation operation such as an autofocus (AF hereinafter) operation. In a case where an S2 operation is detected from this state, the shutter 14 is driven to start the exposure operation for still image capturing. Depending on the setting, it is also possible to perform the exposure operation for still image capturing multiple times in succession by single pressing of the release button.

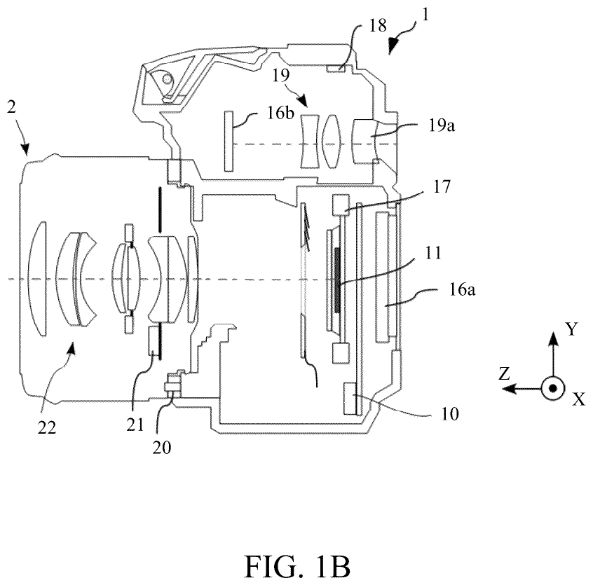

FIG. 2 explains offset component estimation (offset estimation).

The shake detector 18 outputs a detection signal of the shake information on the camera 1 to subtractors 102 and 105.

The motion vector detector 12a outputs the detected motion vector to the adder 101.

An image-stabilizing-member position detector 171 detects the position of the image sensor 11, which is the image stabilizing member in the camera-side image stabilizing unit 17. The output signal of the image-stabilizing-member position detector 171 is output to a differentiator 172.

The differentiator 172 performs differentiation processing for the output signal of the image-stabilizing-member position detector 171. The output signal of the differentiator 172 is output to an adder 101.

The adder 101 adds the motion vector detected by the motion vector detector 12a and the output signal of the differentiator 172. The output signal of the adder 101 is output to the subtractor 102.

The subtractor 102 subtracts the output signal of the adder 101 from the output signal of the shake detector 18. The output signal of the subtractor 102 is output to the offset estimator 103.

The offset estimator 103 estimates the offset component of the output signal of the shake detector 18 based on the output signal of the subtractor 102. The offset component estimated by the offset estimator 103 is output to the subtractor 105.

The estimation control unit 104 changes an update characteristic (setting) used in a case where the offset estimator 103 estimates the offset component. A method of changing the update characteristic of the offset estimation by the estimation control unit 104 will be described later. The output data of the estimation control unit 104 is output to the offset estimator 103.

The subtractor 105 subtracts the offset component estimated by the offset estimator 103 from the output signal of the shake detector 18. The output signal of the subtractor 105 is output to an integrator 106.

The integrator 106 performs integration processing for the output signal of the subtractor 105. The output signal of the integrator 106 is output to the camera-side image stabilizing unit 17.

The camera-side image stabilizing unit 17 converts an output value of the integrator 106 into a correction target value and controls the image sensor 11, which is an image stabilizing member, so as to cancel out movements such as camera shake. As illustrated in FIG. 1A, in a case where the lens 2 includes the lens-side image stabilizing unit 24, the output value of the integrator 106 may also be output to the lens-side image stabilizing unit 24 via the lens contact 20, and converted into a correction target value to control the correction lens such as the shift lens, which is an image stabilizing member.

A description will now be given of an offset estimating method by the offset estimator 103. In a case where the offset estimator 103 includes a linear Kalman filter, a linear Kalman filter can be expressed by the following equations (1) to (7).

$${x}_{t} = A {x}_{t - 1} + B {u}_{t} + {ϵ}_{t} \qquad ( 1 )$$

$${z}_{t} = C {x}_{t} + {δ}_{t} \qquad ( 2 )$$

Equation (1) defines an operation model in state space representation, and equation (2) defines an observation model. “A” represents a system matrix in the operation model, “B” represents an input matrix, and “C” represents an output matrix in the observation model, each of which is expressed by a determinant. εₜ represents process noise, δₜ represents observation noise, and t represents discrete time.

$${\hat{x}}_{t}^{-} = A {\hat{x}}_{t - 1} + B {u}_{t} \qquad ( 3 )$$

$${\hat{P}}_{t}^{-} = A {\hat{P}}_{t - 1} {A}^{T} + {Σ}_{x} \qquad ( 4 )$$

Equation (3) defines an advance estimation value (or advance estimate) in the prediction step, and equation (4) defines advance error covariance. Σₓ defines noise variance in the operation model.

$${K}_{t} = \frac{{\hat{P}}_{t}^{-} {C}^{T}}{( C {\hat{P}}_{t}^{-} {C}^{T} + {Σ}_{z} )} \qquad ( 5 )$$

$${\hat{x}}_{t} = {\hat{x}}_{t}^{-} + {K}_{t} ( {z}_{t} - C {\hat{x}}_{t}^{-} ) \qquad ( 6 )$$

$${\hat{P}}_{t} = ( I - {K}_{t} C ) {\hat{P}}_{t}^{-} \qquad ( 7 )$$

Equation (5) is an equation for calculating a Kalman gain in the filtering step, and the subscript T represents a transposed matrix. Equation (6) defines a posterior estimation value (or posterior estimate) by the Kalman filter, and equation (7) defines a posterior error covariance. Σ_{z} represents noise variance of the observation model.

In this embodiment, in order to estimate the offset component of the output signal of the shake detector 18, an offset component of the output signal of the shake detector 18 is expressed by xₜ, and a shake amount observed (detected) by the shake detector 18 (output of the shake detector 18) is expressed by zₜ. εₜ is process noise and δₜ is observation noise. Then, a model representing the offset component can be expressed by the following first-order linear model in which there is no input term u in equation (1) and A=C=1 in equations (1) and (2).

$${x}_{t} = {x}_{t - 1} + {ϵ}_{t} \qquad ( 8 )$$

$${z}_{t} = {x}_{t} + {δ}_{t} \qquad ( 9 )$$

The Kalman filter can be expressed by the following equations:

$${\hat{x}}_{t}^{-} = {\hat{x}}_{t - 1} \qquad ( 10 )$$

$${σ}_{{\hat{x}}_{t}^{-}}^{2} = {σ}_{{\hat{x}}_{t - 1}}^{2} + {σ}_{x}^{2} \qquad ( 11 )$$

$${k}_{t} = \frac{{σ}_{{\hat{x}}_{t}^{-}}^{2}}{{σ}_{{\hat{x}}_{t}^{-}}^{2} + {σ}_{{z}_{t}}^{2}} \qquad ( 12 )$$

$${\hat{x}}_{t} = {\hat{x}}_{t}^{-} + {k}_{t} ( {z}_{t} - {\hat{x}}_{t}^{-} ) \qquad ( 13 )$$

$${σ}_{{\hat{x}}_{t}}^{2} = ( I - {k}_{t} ) {σ}_{{\hat{x}}_{t}^{-}}^{2} \qquad ( 14 )$$

where

$${σ}_{x}^{2}$$

is a system noise variance representing the noise variance Σₓ in the operation model in equation (4),

$${σ}_{z}^{2}$$

is observation noise variance representing the noise variance Σ_{z} in the observation model in equation (5),

$${\hat{x}}_{t}^{-}$$

is an advance estimation value at time t,

$${σ}_{{\hat{x}}_{t}}^{2}$$

is posterior error variance, kₜ is a Kalman gain,

$${σ}_{{z}_{t}}^{2}$$

is observation noise variance, zₜ is a shake amount observed by the shake detector 18.

The offset estimator 103 is expressed by equations (10) to (14), and the advance estimation value \hat{x}⁻ and advance error variance

$${σ}_{{\hat{x}}_{\overline{t}}}^{2}$$

are calculate using the offset estimate value \hat{x}ₜ₋₁ at time t−1 of the update period of the estimation calculation, the system noise variance

$${σ}_{x}^{2}$$

output by the shake detector 18, and the posterior error variance

$${σ}_{{\hat{x}}_{t - 1}}^{2}$$

at time t−1. The Kalman gain kₜ is calculated based on the advance error variance

$${σ}_{{\hat{x}}_{\overline{t}}}^{2}$$

and the observation noise variance

$${σ}_{{z}_{t}}^{2} .$$

The advance estimation value \hat{x}⁻ is corrected using equation (13) and a value obtained by multiplying an error between the shake amount zₜ observed by the shake detector 18 and the advance estimation value \tilde{x}⁻ by the Kalman gain kₜ, and the offset estimation value \hat{x}ₜ is calculated. Using equation (14), the advance error variance

$${σ}_{{\hat{x}}_{\overline{t}}}^{2}$$

is corrected and the posterior error variance

$${σ}_{{\hat{x}}_{\overline{t}}}^{2}$$

is calculated. Due to these calculations, the advance estimation update and correction are repeated for each calculation cycle, and the offset estimation value is calculated.

In the above description, the output of the shake detector 18 is used as the observed value of the offset component. However, this embodiment performs offset estimation using as the observed value of the offset component a difference between the output of the shake detector 18 and a signal obtained by adding the motion vector and the image-stabilizing-member moving speed obtained by differentiating the output of the image-stabilizing-member position detector 171.

A description will now be given of the image stabilization with image combination performed by the image combining unit 12b.

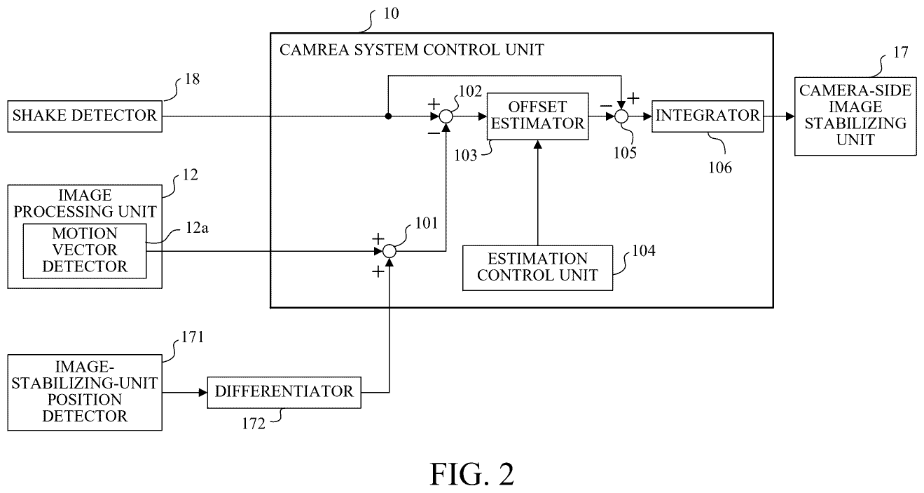

Referring now to FIGS. 3A and 3B, a description will be given of a specific example and effect of image stabilization with image combination. FIGS. 3A and 3B illustrate a relationship between an exposure period and an image blur amount in image stabilization with image combination. In FIGS. 3A and 3B, a vertical axis represents the blur amount, and a horizontal axis represents the exposure period. Broken lines 31, 33, and 33a to 33c represent blur amounts in a case where image stabilization with image combination is not performed, and the broken lines 33a to 33c are obtained by sliding the broken line 33 in the exposure period direction. Solid lines 32a-32d, 34, and 34a-34c represent blur amounts per pre-combined image that is used for the image stabilization with image combination. B₁ represents a blur amount in a case where image stabilization with image combination is not performed and the total exposure period is 1 second, and B₂ and B₃ represent blur amounts in a case where image stabilization with image combination is performed and the total exposure period is 1 second.

Image stabilization with image combination is a technology that divides the exposure period required to acquire one combined image (referred to as a total exposure time hereinafter) into a plurality of short exposure periods (referred to as image acquiring intervals hereinafter) and aligns and combines the plurality of images obtained at each image acquiring interval. The sum of the image acquiring intervals is the total exposure time. The image stabilization with image combination can reduce an image blur while obtaining the same exposure as that in imaging with the total exposure time, and this technology is more effective in a case where the total exposure time is long. For example, as illustrated in FIG. 3A, in the case of imaging with a total exposure time of 1 second and an image acquiring interval of ¼ second, four images are captured continuously within the total exposure time, and these images are aligned and combined.

Without image stabilization with image combination, offset estimation cannot be performed during the exposure period, accurate image stabilization cannot be performed, and thus a blur amount continues to increase from the start to the end of exposure as illustrated by a broken line 31. On the other hand, with image stabilization with image combination, exposure is performed multiple times at the image acquiring interval, so the blur amount in the last exposure period can be returned to zero by image alignment as illustrated by the solid lines 32a to 32d each time exposure starts. These aligned images are then combined to form a single combined image, so if the alignment is properly performed, the blur amount in the image will be B₂, which is the blur amount in the solid line 32d, and can be suppressed to be lower than the blur amount B₁ in a case where image stabilization with image combination is not performed. However, this method does not perform offset estimation during the exposure period, and does not remove the offset component that occurred during the exposure period. Therefore, even if the total exposure time is divided by the image acquiring interval, the longer the total exposure time is, the less blurring can be achieved compared to a case where image stabilization with image combination is not performed. However, since accurate image stabilization is not performed, an increase of blur amount cannot be suppressed. However, during image stabilization with image combination, a plurality of images are acquired at the image acquiring intervals within the total exposure time, so motion vectors can be acquired even during the exposure period and the offset estimation can be performed.

FIG. 3B illustrates a relationship between the exposure period and the blur amount in a case where offset estimation is performed during the exposure period. In this case, the blur amount in the last exposure period is reduced to zero by image alignment when exposure is started at the image acquiring interval, and the offset component that occurred during the last exposure period is removed by offset estimation. Therefore, an increase of blur amount at each exposure start timing is expressed by a line obtained by sliding the broken line 33 for each exposure start timing, as illustrated by the broken lines 33a to 33c, and a blur amount per image becomes B₃ as illustrated by the solid lines 34a to 34c similar to the initial solid line 34. If alignment is also properly performed during image combination, a blur amount becomes B₃, and although the total exposure time is long, the blur amount can be reduced to that equivalent to the image acquiring interval.

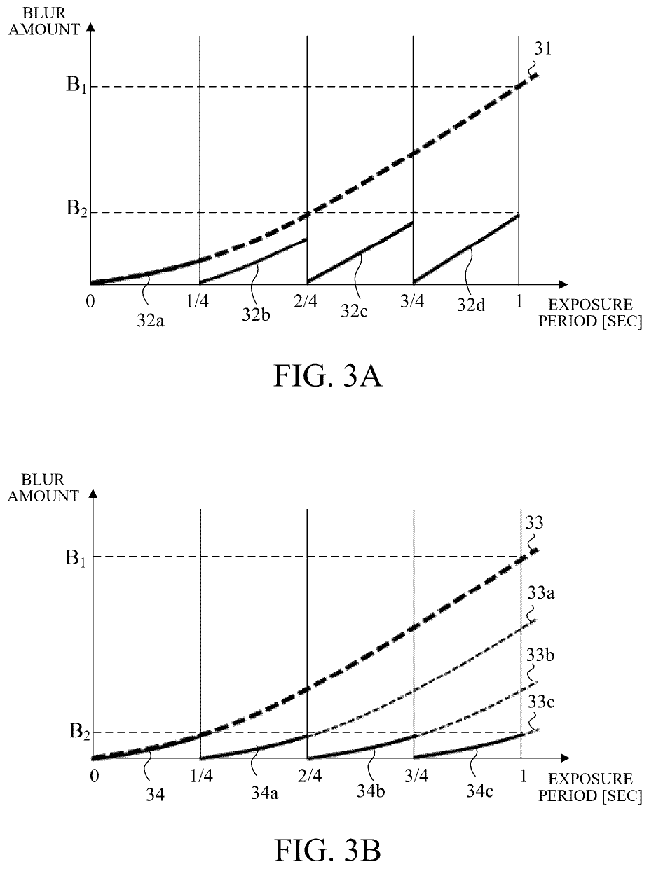

The configuration of the image combining unit 12b will be described below. FIG. 4 is a block diagram of the image combining unit 12b.

The motion vector detector 12a detects a motion vector between a plurality of images obtained from the image sensor 11 and outputs it to an alignment amount calculator 121.

The image combining unit 12b includes the alignment amount calculator 121 and an alignment/combination unit 122.

The alignment amount calculator 121 calculates an alignment amount for a plurality of images based on the motion vector obtained from the motion vector detector 12a, and outputs it to the alignment/combination unit 122.

The alignment/combination unit 122 aligns and combines the plurality of input images based on the alignment amount for the plurality of images obtained from the alignment amount calculator 121.

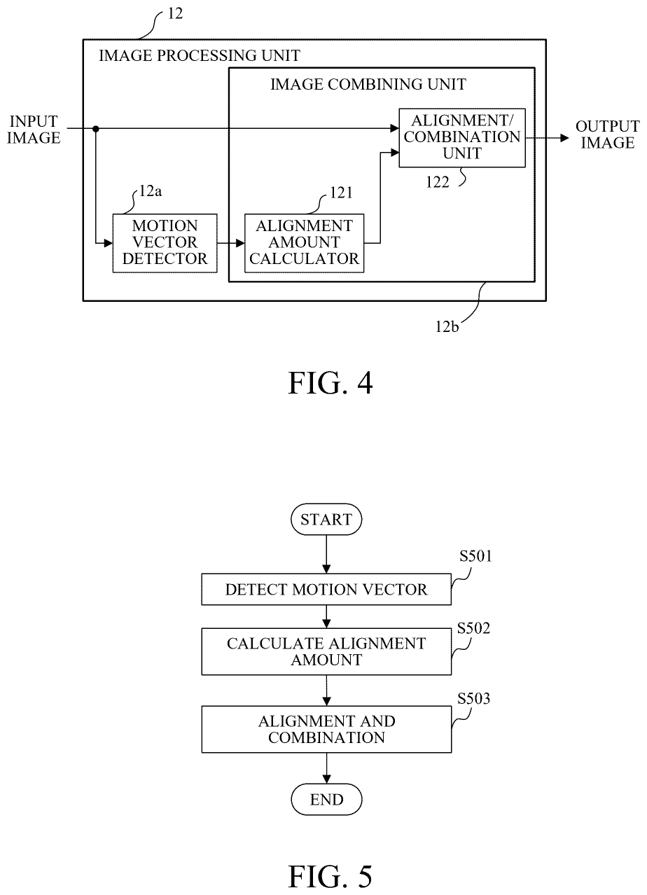

The flow of the image stabilization with image combination process will be described below. FIG. 5 is a flowchart illustrating the processing of image stabilization with image combination, which starts when an image is input from the image sensor 11 to the image processing unit 12.

In step S501, the motion vector detector 12a detects motion vectors between multiple images obtained from the image sensor 11. The motion vector can be detected by extracting feature points from the images and determining the correspondence between the feature points. The feature points can be extracted using a well-known corner detection method. The correspondence between the feature points can be determined using a well-known template matching or feature amount matching method. If the reliability of matching is low, it is highly likely that the correspondence between the feature points has not been determined correctly, so the motion vector may be detected after these feature points are excluded.

In step S502, the alignment amount calculator 121 calculates the alignment amount for the plurality of images based on the motion vectors obtained in step S501. The method of expressing the alignment amount differs depending on the blur component to be corrected. In a case where only the translational blur component is corrected, the alignment amount is expressed as the moving amount in the horizontal and vertical directions. In this case, a histogram may be generated for each of the moving amount in the horizontal direction and the moving amount in the vertical direction for the motion vector, and the mode of each histogram may be calculated. Since this mode is a representative value of the blur occurring between frames, an alignment amount that cancels the blur can be obtained by taking the inverse sign of this mode. On the other hand, in a case where the rotational blur component is also corrected in addition to the translational blur component, it is expressed by a projective transformation matrix (or affine transformation matrix) that indicates the correspondence between images. In this case, the projective transformation matrix can be calculated by a known method such as the least squares method from the correspondence between the feature points between frames obtained from the motion vector. Since the calculated projective transformation matrix represents the blur occurring between frames, an alignment amount that cancels the blur can be obtained by calculating the inverse matrix of this matrix.

In step S503, the alignment/combination unit 122 aligns and combines the plurality of images input based on the alignment amounts of the plurality of images obtained in step S502. The images are aligned by geometrically transforming them using the obtained alignment amounts. The aligned images are added and combined to achieve image stabilization with image combination. In a case where each of the aligned images is captured with proper exposure, the images are added and then averaged. In a case where the aligned images are combined, the combined image is output to the memory 13 and stored.

Offset estimation with image stabilization with image combination has the following problems. Image stabilization with image combination captures a plurality of images at image acquiring intervals within the total exposure time and thus can acquire a motion vector, but the opportunity to acquire the motion vector is only between the exposure periods in the image acquiring intervals. Therefore, the offset estimate value can only be updated at that timing. In order to remove, in a non-exposure period between the image acquiring intervals, an error due to offset components that occurred during the last exposure period, the offset-estimation update speed may be increased (the correction degree of the estimation value may be increased with the offset estimation update). In other words, the time to estimate the offset component may be reduced. To achieve this using a Kalman filter, the Kalman gain kₜ expressed by equation (12) may be increased.

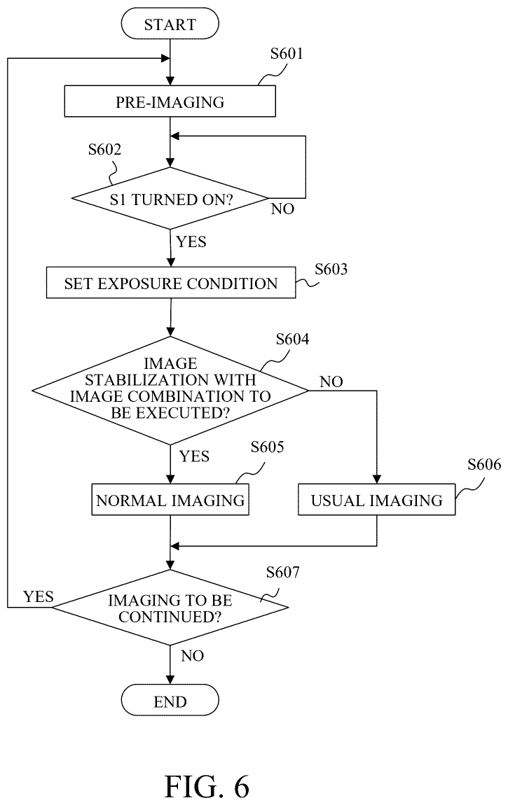

Referring now to FIG. 6, a description will be given of the flow of the imaging operation. FIG. 6 is a flowchart illustrating a still image capturing operation with image stabilization with image combination. This flow is started when the camera 1 is powered on or the mode is switched from another mode to the still image capturing mode while the power is turned on.

In step S601, the camera system control unit 10 starts a pre-imaging operation. Pre-imaging is an operation in which the image sensor 11 continuously acquires a plurality of images to be used for display on the display unit 16 in the live-view imaging.

In step S602, the camera system control unit 10 determines whether or not an S1 operation, which is an imaging preparation operation instruction, has been performed. In a case where the camera system control unit 10 determines that the S1 operation has been performed, it executes the processing of step S603, and if it determines that the S1 operation has not been performed, it executes the processing of this step again.

In step S603, the exposure condition setting unit 107 sets the exposure condition. This step sets the total exposure time and the image acquiring interval for imaging with image stabilization with image combination. At this time, if the F-number, ISO speed, and the like have already been set in the camera 1, the exposure condition may be automatically set from that information, or may be manually set by the user of the camera 1 via the operation unit 15. In this embodiment, the exposure condition setting unit 107 acquires the image acquiring interval, but may set the number of images.

In step S604, the image combination determining unit 108 determines whether or not to perform image stabilization with image combination based on the exposure condition set in step S603. In a case where the total exposure time and the image acquiring interval are different, the image combination determining unit 108 determines that image stabilization with image combination is to be performed, and the camera system control unit 10 executes the processing of step S605. In a case where the total exposure time and the image acquiring interval are the same, the image combination determining unit 108 determines that image stabilization with image combination is not to be performed, and the camera system control unit 10 executes the processing of step S606.

In step S605, the camera system control unit 10 causes the normal imaging operation to be performed. The normal imaging is an operation in which the image sensor 11 successively acquires a plurality of images to be used by the alignment/combination unit 122 with a single imaging instruction (S2 operation).

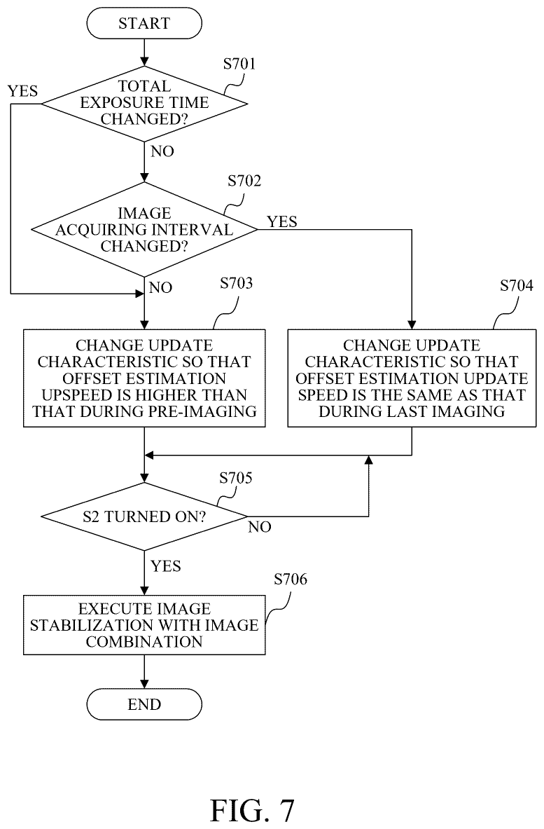

FIG. 7 is a flowchart illustrating the processing during the normal imaging, and the flow is started when it is determined in step S604 that image stabilization with image combination is to be performed.

In step S701, the exposure condition setting unit 107 determines whether or not the total exposure time set in step S603 has changed since the last imaging. In a case where the exposure condition setting unit 107 determines that the total exposure time has changed since the last imaging, it executes the processing of step S703, and in a case where it determines that the total exposure time has not changed, it executes the processing of step S702.

In step S702, the exposure condition setting unit 107 determines whether or not the image acquiring interval set in step S603 (predetermined imaging timing) has changed since the last imaging (the last imaging timing of the predetermined imaging timing). In a case where the exposure condition setting unit 107 determines that the image acquiring interval has changed since the last imaging, it executes the processing of step S704, and in a case where it determines that the image acquiring interval has not changed, it executes the processing of step S703.

In step S703, the estimation control unit 104 changes the update characteristic so that the offset-estimation update speed is higher than that during pre-imaging in step S601. The update characteristic change here is to increase the Kalman gain kₜ during normal imaging larger than that during pre-imaging.

During pre-imaging as live-view imaging, images are always displayed on the display unit 16, so images are continually acquired at short intervals and offset estimation can always be performed. However, during this time, the user performs a framing operation such as determining an object and composition while viewing the image displayed on the display unit 16, so even if the camera 1 is fixed, low-frequency shake caused by the user's movement is carried as noise in the offset component observation value. Therefore, during pre-imaging, the Kalman gain kₜ is set so that it is not affected by the noise carried on the offset component observation value during offset estimation. On the other hand, during normal imaging, the user holds and fixes the camera 1 to capture the object, so a low-frequency blur caused by the user's movement can be suppressed. Therefore, since there is no unnecessary noise in the offset component observation value, the offset component observation value during normal imaging can be more reliable than that during pre-imaging, and the Kalman gain kₜ can be set larger during normal imaging than that during pre-imaging. In order to increase the Kalman gain kₜ, the advance error variance

$${σ}_{{\hat{x}}_{\overline{t}}}^{2}$$

in equation (12) may be greater than the observation noise variance

$${σ}_{{z}_{t}}^{2}$$

or the observation noise variance

$${σ}_{{z}_{t}}^{2}$$

may be smaller than the advance error variance

$${σ}_{{\hat{x}}_{\overline{t}}}^{2} .$$

This embodiment sets the Kalman gain kₜ large using the latter method because the noise in the offset component observation value is reduced while pre-imaging transitions to normal imaging. Thereby, the offset-estimation update speed during normal imaging can be higher than that during pre-imaging, so that the offset component that occurs during exposure at the image acquiring interval in image stabilization with image combination can be removed each time.

In step S704, the estimation control unit 104 changes the update characteristic so that the offset-estimation update speed is the same as that during the last imaging. Here, changing the update characteristic means changing the magnitude of the Kalman gain kₜ so that the offset-estimation update speed is the same as that of the last imaging. The “same” may be exactly the same or substantially the same (approximately the same).

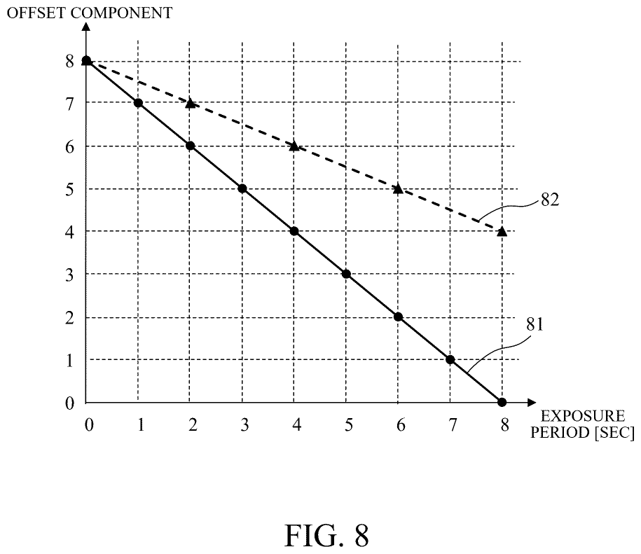

Referring now to FIG. 8, a description will be given of a relationship between the Kalman gain kₜ and the offset-estimation update speed. FIG. 8 illustrates a simplified diagram of the transition of an offset-component removing amount due to differences in image acquiring intervals in a case where the total exposure time is 8 seconds. In FIG. 8, a vertical axis represents an offset component, and a horizontal axis represents an exposure period. A solid line 81 indicates the transition of the offset-component removing amount in a case where the image acquiring interval is set to 1 second, and a broken line 82 indicates the transition of the offset-component removing amount in a case where the image acquiring interval is set to 2 seconds. In addition, “●” and “▴” indicate the offset component at each image acquiring interval.

Even if the Kalman gain kₜ is the same, if the image acquiring interval is different, the offset component corrected by single update of the offset estimation value does not change. Hence, a difference occurs in the offset-estimation update speed, and a difference occurs in the offset-component removing amount at the end of the total exposure time, as illustrated by the solid line 81 and the broken line 82. The slopes of the solid line 81 and the broken line 82 represent the offset-estimation update speeds. In order to match the offset-component removing amount at the end of the total exposure time even if the image acquiring interval is different, the offset-estimation update speed may be adjusted by changing the magnitude of the Kalman gain kₜ. For example, in a case where the image acquiring interval becomes shorter than that of the last imaging, as illustrated from the broken line 82 to the solid line 81, the offset-estimation update speed becomes faster unless the magnitude of the Kalman gain kₜ changes. Thus, the magnitude of the Kalman gain kₜ is set smaller than that of the last imaging, and the offset-estimation update speed is slowed down so that the solid line 81 overlaps the broken line 82. Also, in a case where the image acquiring interval becomes longer than that during the last imaging, as illustrated from the solid line 81 to the broken line 82, the offset-estimation update speed becomes slow unless the magnitude of the Kalman gain kₜ changes. Therefore, the magnitude of the Kalman gain kₜ is set larger than that during the last imaging, and the offset-estimation update speed becomes faster so that the broken line 82 overlaps the solid line 81. Thereby, even if the total exposure time is the same as that during the last imaging and the image acquiring interval is different, the offset-estimation update speed can be kept constant.

In step S705, the camera system control unit 10 determines whether or not the S2 operation, which is an imaging operation start instruction, has been performed. In a case where the camera system control unit 10 determines that the S2 operation has been performed, it executes the processing of step S706, and in a case where it determines that the S2 operation has not been performed, it executes the processing of this step again.

In step S706, the image combining unit 12b performs image stabilization with image combination based on the exposure condition set in step S603 and acquires a combined image.

Turning back to the flowchart in FIG. 6, in step S606, the camera system control unit 10 causes usual still image capturing to be performed for the total exposure time set in step S603, and acquires an image. Here, usual still image capturing refers to imaging in which image stabilization with image combination is not performed, the total exposure time is the exposure period, and a single still image is obtained.

In step S607, the camera system control unit 10 determines whether or not to continue imaging. In a case where the camera system control unit 10 determines that imaging is to continue, it executes the processing of step S601. At this time, the offset-estimation update characteristic of the offset estimator 103 returns to that corresponding to pre-imaging. In a case where the camera 1 is powered off or the mode is switched to a mode other than still image capturing, the camera system control unit 10 determines that imaging is not to continue and ends this flow.

This embodiment determines whether to perform image stabilization with image combination, but may omit this determination if the selected still image capturing mode is premised on the execution of image stabilization with image combination.

The above series of operations can perform image stabilization with high accuracy even during long exposure for still image capturing.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-154431, which was filed on Sep. 9, 2024, and which is hereby incorporated by reference herein in its entirety.

What is claimed is:

1. A control apparatus for use with an image pickup apparatus that includes an imaging unit configured to consecutively acquire a plurality of images, and a combining unit configured to combine the plurality of images based on a motion vector between the plurality of images, the control apparatus comprising:
one or more memories storing instructions; and
one or more processors that, upon execution of the instructions, operate to
estimate an offset component of an output of a detector configured to detect a shake of the image pickup apparatus, and
change a setting for estimating the offset component between pre-imaging for consecutively acquiring a plurality of images that are used for live-view imaging, and normal imaging for consecutively acquiring the plurality of images that are used for the combining unit.

2. The control apparatus according to claim 1, wherein the one or more processors operate to change the setting so that a speed at which the offset component is estimated differs between the pre-imaging and the normal imaging.

3. The control apparatus according to claim 2, wherein the one or more processors operate to change the setting so that a speed at which the offset component is estimated during the normal imaging is faster than a speed at which the offset component is estimated during the pre-imaging.

4. The control apparatus according to claim 1, wherein the one or more processors operate to change the setting according to an image acquiring interval, which is an exposure time per image in acquiring the plurality of images during the normal imaging.

5. The control apparatus according to claim 4, wherein the one or more processors operate to change the setting so that a speed at which the offset component is estimated becomes same in a case where the image acquiring interval changes between a predetermined imaging timing and an imaging timing just before the predetermined imaging timing during the normal imaging.

6. The control apparatus according to claim 1, wherein the one or more processors operate to determine whether or not to perform the normal imaging.

7. The control apparatus according to claim 6, wherein the one or more processors operate to:
set an exposure period for acquiring a single image, and
determine whether or not to perform the normal imaging based on the exposure period.

8. The control apparatus according to claim 1, wherein the one or more processors set an exposure period for acquiring a single combined image in the normal imaging.

9. The control apparatus according to claim 8, wherein the one or more processors operate to set at least one of an image acquiring interval, which is an exposure time per image in acquiring the plurality of images during the normal imaging, and the number of the plurality of images.

10. An image pickup apparatus comprising:
a control apparatus;
an imaging unit configured to consecutively acquire a plurality of images; and
a combining unit configured to combine the plurality of images based on a motion vector between the plurality of images,
wherein the control apparatus includes:
one or more memories storing instructions; and
one or more processors that, upon execution of the instructions, operate to
estimate an offset component of an output of a detector configured to detect a shake of the image pickup apparatus, and
change a setting for estimating the offset component between pre-imaging for consecutively acquiring a plurality of images that are used for live-view imaging, and normal imaging for consecutively acquiring the plurality of images that are used for the combining unit.

11. The image pickup apparatus according to claim 10, wherein the one or more processors operate to change the setting so that a speed at which the offset component is estimated differs between the pre-imaging and the normal imaging.

12. The image pickup apparatus according to claim 11, wherein the one or more processors operate to change the setting so that a speed at which the offset component is estimated during the normal imaging is faster than a speed at which the offset component is estimated during the pre-imaging.

13. The image pickup apparatus according to claim 10, wherein the one or more processors operate to change the setting according to an image acquiring interval, which is an exposure time per image in acquiring the plurality of images during the normal imaging.

14. The image pickup apparatus according to claim 13, wherein the one or more processors operate to change the setting so that a speed at which the offset component is estimated becomes same in a case where the image acquiring interval changes between a predetermined imaging timing and an imaging timing just before the predetermined imaging timing during the normal imaging.

15. The image pickup apparatus according to claim 10, wherein the one or more processors operate to determine whether or not to perform the normal imaging.

16. The control apparatus according to claim 15, wherein the one or more processors operate to:
set an exposure period for acquiring a single image, and
determine whether or not to perform the normal imaging based on the exposure period.

17. The control apparatus according to claim 10, wherein the one or more processors set an exposure period for acquiring a single combined image in the normal imaging.

18. The control apparatus according to claim 17, wherein the one or more processors operate to set at least one of an image acquiring interval, which is an exposure time per image in acquiring the plurality of images during the normal imaging, and the number of the plurality of images.

19. A control method for use in an image pickup apparatus comprising an imaging unit for consecutively acquiring a plurality of images, and a compositing means for compositing the plurality of images based on a motion vector between the plurality of images, the control method comprising:
estimating an offset component of an output of a detector configured to detect a shake of the image pickup apparatus; and
changing a setting for estimating the offset component between pre-imaging for consecutively acquiring a plurality of images that are used for live-view imaging, and normal imaging for consecutively acquiring the plurality of images that are used for the combining unit.

20. A non-transitory computer-readable storage medium storing a program for causing a computer to execute the control method according to claim 19.
